(19) United States
(12) Patent Application Publication
(10) Pub. No.: US 2006/0126863 A1
(43) Pub. Date: Jun. 15, 2006

(54) System and method for controlling a recording studio

(76) Inventor: Louis DePasqua, Round Lake Beach, IL (US)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 11/010,494

(22) Filed: Dec. 13, 2004

(51) Int. Cl. H04B 5/00; H04B 3/00

(52) U.S. Cl. 381/79; 381/77

(57) ABSTRACT

A wireless remote control system for controlling an audio recording system in a recording studio is disclosed. This system incorporates a small wireless remote that can be mounted directly on the user's body that may include an arm, wrist, leg, belt, or any member. This remote controller may also be mounted directly on an instrument. The system will provide the user the freedom to walk around and control all aspects of a studio environment without being tied to one location.

### CROSS-REFERENCE TO RELATED APPLICATIONS

Not applicable.

### FEDERALLY SPONSORED RESEARCH OR DEVELOPMENT

Not applicable.

### TECHNICAL FIELD

The present invention relates to a system for controlling various devices in a recording studio remotely with a wireless remote that mounts on a user's member or their instrument.

### BACKGROUND OF THE INVENTION

Music recording studios have been around for many years. These audio recording studios contain many different types of recording equipment to capture and store the musical performance of a musician. The history of audio recordings dates all the way back to the late 1800's when Thomas Edison first invented an audio recording device that was able to record and play back audio material from a tinfoil cylinder phonograph. Through the years, the methods for recording audio have advanced from tinfoil to digital audio storage devices used today. The method for controlling the transport functions of these recording and playback devices is quite simple. The user has a transport control device that contains several buttons that may include stop, play, rewind, fast forward, return, record enable and others. This transport control device may be a keyboard or mouse for a computer or may be a large wireless or wired remote transport device that must be set on a table or desktop or must be held in the users hand while operating the audio recording device. These known methods for controlling a recording system are limited because the user must be located at the specific location or the remote transport must be hand held and set down when not in use. Additionally, other studio operations such as muting a channel, adding or changing acoustic effects, launching a software instruction set in a digital audio device such as MIDI or any other such device requires a separate control interface which, traditionally is located contiguous to the controlled device in the studio control room rather than in the recording artist's reach.

The present invention is provided to solve the problems discussed above and other problems, and to provide advantages and aspects not provided by prior systems and methods of this type. A full discussion of the features and advantages of the present invention is deferred to the following detailed description, which proceeds with reference to the accompanying drawings.

### SUMMARY OF THE INVENTION

It is the primary object of the present invention to disclose a remote control studio device controller that is adapted to allow the user the freedom to move freely about a recording environment while maintaining control of the studio equipment.

It is another object of the invention to provide a remote control device that is small and can be mounted on the user's wrist, neck strap, belt, other member or instrument.

It is a further object of the invention to provide for a remote control that has several studio controls including the following: stop; play; rewind; fast forward; return; record enable; and volume.

It is another object of the invention to provide, optionally, extra control buttons that may be programmed by the user to control custom commands in the recording system such as: record delete; talk back microphone enable; headphone level; system volume dim; MIDI preset or any other control parameter settings.

It is another object of the invention to provide a remote system that will interface with the recording system via MIDI, direct wired connection or computer USB or other input port.

It is a further object of the invention to provide for a recording studio remote controller that allows for control of a recording studio without the need to pick up a remote by hand.

It is another object of the invention to provide for a recording studio remote controller adapted to allow for control of a variety of recording system components.

Other objects, features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of the remote controller transmitter.

FIG. 2 is a perspective view of the receiver/interface.

FIG. 3 is a schematic of the remote controller transmitter.

FIG. 4 is a schematic of the receiver/interface.

FIG. 5 is a perspective view of the remote controller transmitter mounted on a representative instrument.

FIG. 6 is a perspective view of the remote controller transmitter mounted on a wrist.

FIG. 7 is a block diagram of the receiver connected to a variety of representative studio devices.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

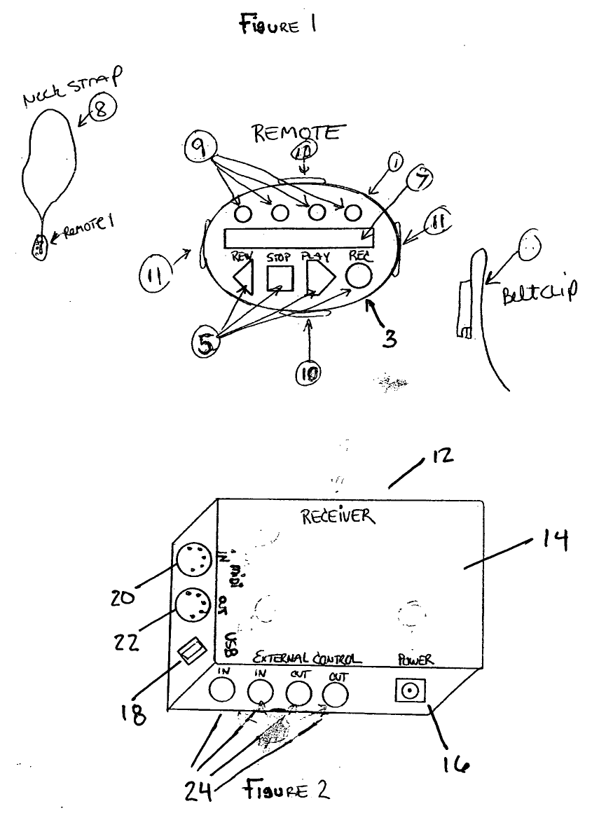

Referring to FIG. 1, the remote controller 1 comprises a case 3 containing the electronic components and the control actuators. The first set of such actuators is a series of recorder control buttons 5 which are operative through associated electronics to cause a remote recording device to execute the appropriate transport functions such as: stop; play; record and rewind. In the preferred embodiment, these buttons are single pole instantaneous pushbutton switches, although the invention comprises the use of differing actuators such as membrane switches, touch screens and the like. Also located on the case 3 is an information screen 7 which preferably an LCD display although other types of displays are contemplated as necessitated by the use of the device. This screen 7 can be programmed to display a variety of studio functions such as tape index, MIDI program loaded, or the status of an electronic audio effect like flange or reverb.

The case 3 also houses a plurality of soft keys 9 which can be programmed to allow access and control of any of a variety of studio devices or preset programs in MIDI format or alternatively allow control of an automated audio signal processing software suite resident on a remote computer such as ProTools® by Digidesign Inc. Additionally, these soft keys 9 can by appropriate connection of the receiving end of the remote control system be wired into a recording console patch bay for remote patching of various effects or into a channel input to allow for remote muting, tone control, or fade through either the channel voltage controlled amplifier, if so equipped or the appropriate motor control circuit for those consoles that have electromechanical automation.

Additionally, these soft keys 9 can be programmed to allow for a sequence of audio automation programs to be accessed. This is accomplished by programming one or more of the soft keys 9 to act as a toggle between a plurality of programs accessed by a computer to which the receiver 12 is connected. The case 3 also has a first set of mounts 10 and a second set of mounts 11 which are adapted to receive a mounting strap 8. The first set of mounts 10 allow the case 3 to be mounted onto a narrow aspect member such as a wrist or guitar neck while the second set of mounts 11 allows the wider axis of the case 3 to be utilized for mounting the remote 1 to a thicker aspect member such as a leg or guitar body. Also, the mounts 10, 11 may be used singly to allow the case 3 to be hung from the neck or belt of the operator.

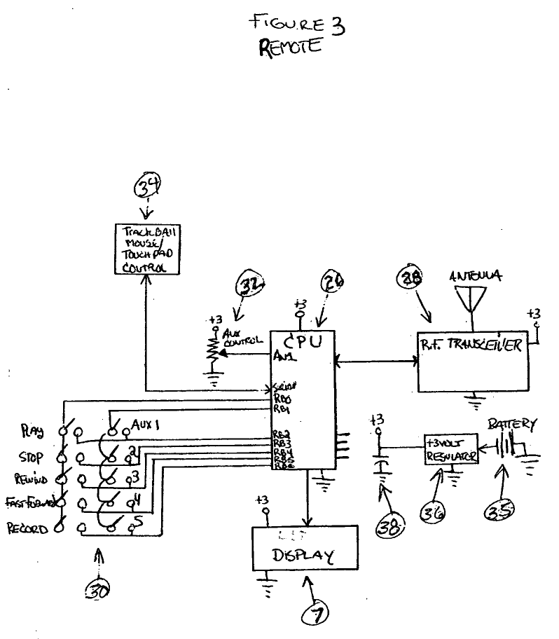

As shown in FIG. 2, the receiver 12 comprises a receiver body 14 which supports the internal electronics as well as providing for a power connection 16, a USB port 18, MIDI format in port 20, MIDI format out port 22, as well as external control ports 24. Operationally, the USB port 18 provides for programming of the device as well as allowing received instructions from the remote 1 to be input to a computer. In programming the device, a supplied program will display an image of the receiver 1 on a screen. The operator will assign the routing of instructions received from the remote 1 by the receiver 12, as well as the actions of the soft keys 9. Electronics internal to the receiver, which will be subsequently described, route the received instruction to the appropriate external device. The USB port 18 allows the receiver to transmit instructions to a USB equipped device such as another computer, tape deck or the like. MIDI ports 20, 22 allow the receiver 12 to communicate with MIDI enabled devices. Control ports 24 allow the receiver to receive information from non-MIDI devices such as tape decks, certain effects and the like as well as controlling such devices through signals output through these ports.

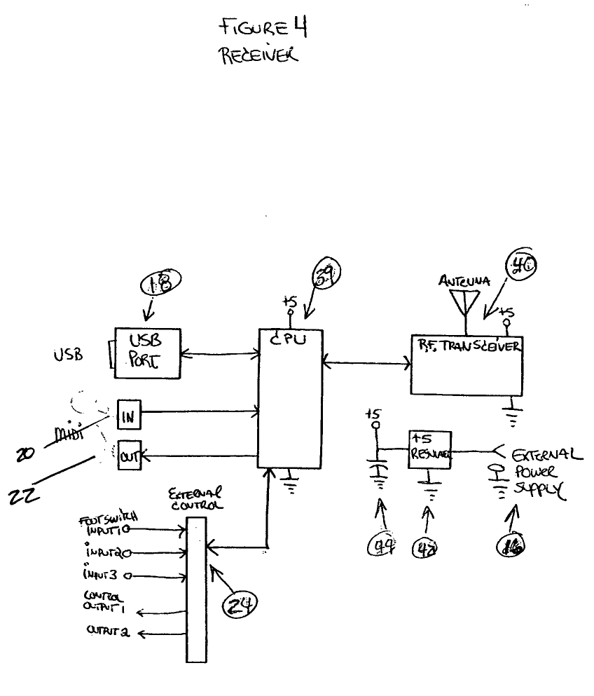

FIG. 3 shows a block schematic diagram of the internal components of the remote 1. CPU 26 controls all electronic functions that include the R.F. transceiver 28 and communications to the receiver and back to the remote for display updates. Display 7 is used to display various functions in the system as previously described. The display 7 will show system status that includes button status and menu modes when the soft keys 9 are configured into a toggle menu. The switch button matrix 30 is used for the eight remote function buttons. The analog potentiometer 32 is an option for variable data entry. A computer display pointer control 34 may also be incorporated into the remote 1. The user may control the computer display pointer remotely. The power is supplied by a small battery 35, which is regulated by the 3 volt regulator 36 and filter capacitor 38. These components provide power to the remote 1 circuitry.

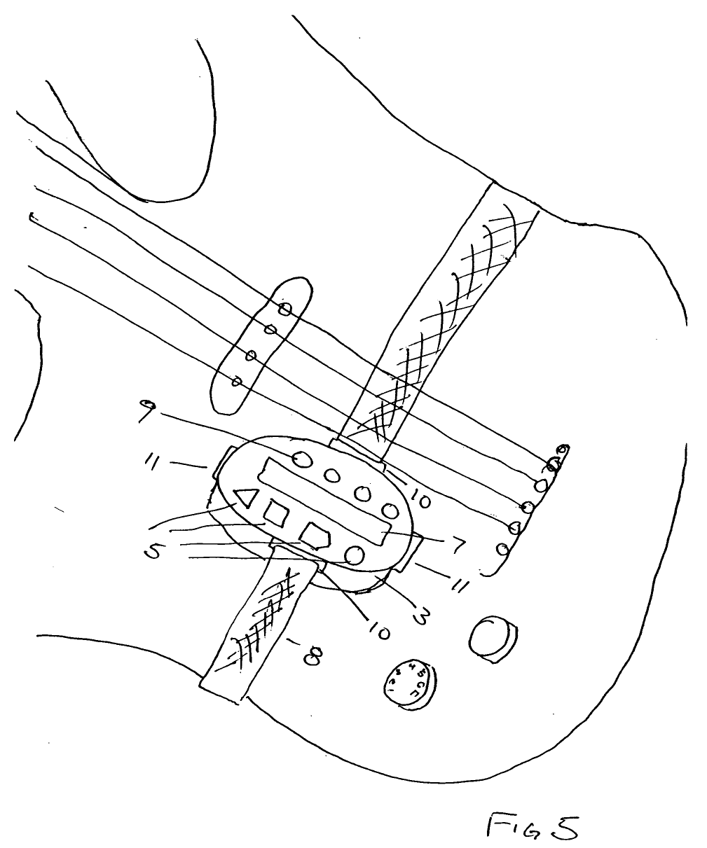

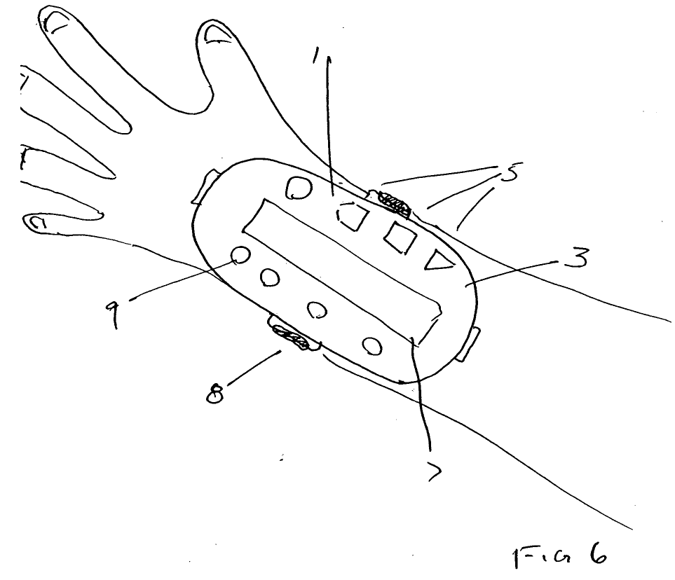

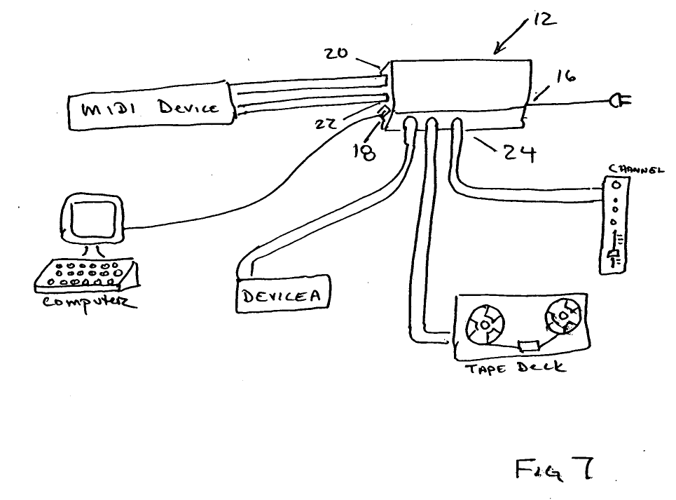

FIG. 4 shows a schematic block diagram of the receiver module 12. EEPROM type CPU 39 is used to process all of the data input and output in the system. The R.F. circuit 40 is used to communicate with the remote 1. Signals are transmitted and received by this circuit. The USB port 18 is used to communicate with the computer. USB port 18 provides transport/software control and system programming. MIDI ports 20, 22 are used to control transport functions and preset selections on digital work stations, keyboards, and guitar rigs and other MIDI devices. External control ports 24 can be programmed to control external devices like talkback microphones, and speaker selection via the remote 1 as previously described. The external control ports 24 can be configured to provide external foot pedal control of the recording system. The power supply input is provided by an external transformer that is connected to the receiver module 12 though connector 16. The external voltage is regulated by regulator 42 and filter capacitor 44.

In operation, the user would first connect the receiver 12 to an external computer in which the supplied program has been loaded. The user would then assign routing and instruction sets corresponding to the various external devices which are to be controlled as well as functions associated with the soft keys 9. After the receiver 12 has been connected to the appropriate external devices, the remote 1 can be used. The remote 1 then is attached to a member or instrument using the appropriate mounts 10, 11 and strap 8 allowing the user to control the external devices while moving about the studio environment. During operation, when a soft key 9 or button 5 is pressed, a signal packet is sent from the remote 10 to the receiver 12 using a transmission protocol; preferably 802.15.4 although 802.11 or 802.11A can also be used. The internal electronics in the receiver 12 as described then assigns a control action for the packet received in accordance with the programming previously input into the receiver CPU 39. This control action, previously determined by the operator during programming, causes an appropriate signal to be generated and sent via an output port (i.e., USB port 18, MIDI port 22, or external control ports 24 to the pre-selected external device as appropriate). A signal is then generated by receiver 12 and sent to the remote 1 to update the screen 7 as required. A simpler version of the system could dispense with the screen and thereby the necessity of having the remote 1 being capable of receiving signals from the receiver 12.

This description of the presently preferred embodiment is intended as illustrative of the preferred mode of executing the invention and is not intended to restrict the invention in any way over such restrictions as recited in the Claims appended hereto.

What is claimed is:

1. A system for remotely controlling devices in a recording studio, comprising a mobile remote control capable of sending information carrying transmissions to a receiver, wherein the receiver is programmed to execute specified operations operative to control at least one studio device operatively connected to the receiver during at least the receipt of the signals, wherein the remote control is adapted to be removeably mounted on a member associated with an operator of the remote control.

2. The system of claim 1, wherein the remote control further comprises a case shaped to define long and short axes thereon, the long axis being adapted to facilitate mounting of the remote control on at least one member having a thick aspect and the short axis being adapted to facilitate mounting of the remote control on at least one member having a thin aspect.

3. The system of claim 1, wherein the remote control further comprises a plurality of buttons operative to execute fixed commands upon actuation.

4. The system of claim 1, wherein the remote control further comprises at least one soft key operative to execute a user defined command.

5. The system of claim 4, wherein the soft key is further operative to sequentially actuate commands selected from a menu of commands upon repeated activation.

6. The system of claim 4, wherein the remote control further comprises a plurality of the soft keys operative to execute different user defined commands.

7. The system of claim 1, wherein the member is selected from: an operator's neck, an operator's leg, an operator's wrist, a belt associated with the operator, a musical instrument, or a stand.

8. A method for controlling a process of recording audio signals, comprising the steps of:
providing a remote control associatable with an operator and capable of being removeably mounted on a member thereof;
providing a receiver operative to execute a command upon receipt of a signal generated by the remote control wherein the command is effective to control a device operably connected to the receiver;
programming the receiver with the command; and,
actuating the remote control by the operator causing the remote control to generate the signal.

9. The method of claim 8, further comprising the steps of:
providing an informational screen on the remote control;
wherein the receipt of the signal generated by the remote causes the receiver to generate an informational signal to the remote; and,
displaying the informational signal on the screen.

10. The method of claim 8, wherein the step of programming the receiver with the command further comprises:
providing software residing on a computer operatively connected to the receiver;
providing a user with a simulation of the remote control on a screen associated with the computer;
assigning at least one operative command to the receiver in response to the user assigning commands to the simulation of the remote control; and,
programming the receiver with the command.

11. A remote control system for recording studio equipment, comprising:
a remote transceiver associated with an operator and releaseably affixable to a member associated therewith; and,
a receiver operative to receive commands from the remote transceiver, the receiver comprising a programmable internal processor operative to assign specific actions to the commands received from the transceiver, and the receiver being operative to transmit information to the transceiver in response to receipt of the commands.

12. The remote control system of claim 11, wherein the programmable internal processor is programmed by software resident on a computer operative associated with the receiver wherein the software creates a simulation of the transceiver to facilitate programming of the programmable internal processor by associating commands input on the simulation with commands as executed by the programmable internal processor.

13. The remote control system of claim 12, wherein the software is further operative to support a menu of commands assignable to a soft key resident on the transceiver.

14. The remote control system of claim 13, wherein the soft key is operative to sequentially access commands on the menu by repeated actuation of the soft key.

15. The remote control system of claim 11, wherein the transceiver further comprises an informational screen operative to display the information transmitted by the receiver.

16. The remote control system of claim 11, wherein the transceiver comprises an ovoid case having a long axis and a short axis wherein the case comprises mounts located at the termini of the long axis and the short axis, and wherein the case is releaseably mountable along either the long axis or the short axis.

17. The remote control system of claim 11, wherein the transceiver comprises actuators operative to select and transmit commands to the receiver upon actuation.

18. The remote control system of claim 17, wherein the actuators comprise a plurality of buttons operative to send fixed commands assigned to each of the buttons and a plurality of soft keys operative to send user selected commands selectively assigned to each of the soft keys.

19. The remote control system of claim 11, wherein the receiver comprises:
a USB port operative to program the receiver and transmit programmed commands to a USB-enabled device;
a MIDI input port for receiving information from a MIDI format device;
a MIDI output port for transmitting commands to a MIDI format device; and,
a plurality of output ports for transmitting commands to analog input devices.

20. The remote control system of claim 16, wherein the member is selected from: an operator's neck, an operator's leg, an operator's wrist, a belt associated with the operator, a musical instrument, or an instrument stand.
